(19) United States
(12) Patent Application Publication
(10) Pub. No.: US 2026/0093197 A1
(43) Pub. Date: Apr. 2, 2026

(54) HEATING DEVICE, FIXING DEVICE, AND IMAGE FORMING APPARATUS

(71) Applicant: KYOCERA Document Solutions Inc., Osaka (JP)

(72) Inventors: Yuhiro Sakai, Osaka (JP); Masakazu Uehara, Osaka (JP); Tomohiro Watatani, Osaka (JP)

(21) Appl. No.: 19/331,709

(22) Filed: Sep. 17, 2025

(30) Foreign Application Priority Data
Sep. 30, 2024 (JP) 2024-170771

(51) Int. Cl. G03G 15/20

(52) U.S. Cl. CPC G03G 15/2053; G03G 15/2064; G03G 2215/2035

(57) ABSTRACT

A heater which is held by a base member includes a plurality of resistors arrayed on its surface. A plurality of input electrodes which are electrically connected to the resistors are formed on an end portion of the heater, and are arranged on an end portion of the base member. A connector includes a nip portion including a pair of arm portions that nip the base member end portion and a plurality of output electrodes which are arranged on inner surfaces of the pair of arm portions and come into contact with the plurality of input electrodes. A sheet member is adhered to an end surface of the base member end portion and a side surface of the nip portion and closes a gap between the end surface of the base member end portion and the side surface of the nip portion.

### INCORPORATION BY REFERENCE

This application is based upon and claims the benefit of priority from the corresponding Japanese Patent Application No. 2024-170771 filed on September 30, 2024, the entire contents of which are incorporated herein by reference.

### BACKGROUND

The present disclosure relates to a heating device including a plurality of resistors arrayed on a surface of a base member, a fixing device, and an image forming apparatus.

An image forming apparatus that uses electrophotography includes a fixing device which heats and pressurizes a toner image transferred onto a paper sheet. The fixing device includes a heating device, a fixing member which is heated by the heating device, and a pressure member which rotates while biasing the paper sheet on which the toner image has been formed toward the fixing member.

In the fixing device, the heating device may include a base member and one or more planar resistance blocks arranged on a surface of the base member. The resistance block includes a plurality of resistors arranged along a main direction. The main direction is a direction that intersects with a conveying direction of the paper sheet.

The resistance block is supplied with power through a plurality of input electrodes arranged on a surface of an end portion of the base member in the main direction.

For example, it is known that a connector includes a plurality of output electrodes supplied with power from a power source, and the connector is attached to the end portion of the base member. By attaching the connector to the end portion of the base member, the plurality of output electrodes come into contact with the plurality of input electrodes.

### SUMMARY

A heating device according to an aspect of the present disclosure includes a heater, a base member which holds the heater, a connector, and sheet member. The heater include a plurality of resistors arrayed in a main direction:. The plurality of input electrodes which are electrically connected to the plurality of resistors on a surface of an end portion of the heater in the main direction. The connector includes a nip portion including a pair of arm portions that nip a base member end portion which is an end portion of the base member and a plurality of output electrodes which are arranged on inner surfaces of the pair of arm portions and come into contact with the plurality of input electrodes. The sheet member is adhered to an end surface of the base member end portion and a side surface of the nip portion and closes a gap between the end surface of the base member end portion and the side surface of the nip portion.

A fixing device according to another aspect of the present disclosure includes the heating device, a cylindrical fixing member heated by the heating device, and a pressure member which rotates while biasing a paper sheet on which a toner image has been formed toward the fixing member.

An image forming apparatus according to another aspect of the present disclosure includes an image forming portion, a transfer device, and the fixing device. The image forming portion forms a toner image on a surface of an image-carrying member. The transfer device transfers the toner image from the image-carrying member onto a paper sheet. The fixing device heats and pressurizes the toner image formed on the paper sheet.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus including a heating device according to a first embodiment;

FIG. 2 is a configuration diagram of a fixing device including the heating device according to the first embodiment;

FIG. 3 is a plan view of a heating surface in the heating device according to the first embodiment;

FIG. 4 is a block diagram showing a configuration of a control device in the image forming apparatus;

FIG. 5 is an exploded perspective view of a base member end portion and a connector in the heating device according to the first embodiment, as viewed from a lower surface side;

FIG. 6 is an exploded perspective view of the base member end portion and the connector in the heating device according to the first embodiment, as viewed from an upper surface side;

FIG. 7 is a side view of the base member end portion and the connector before a sheet member is attached in the heating device according to the first embodiment;

FIG. 8 is a side view of the base member end portion and the connector in the heating device according to the first embodiment;

FIG. 9 is a side view of a base member end portion and a connector in a heating device according to a second embodiment; and

FIG. 10 is a side view of a base member end portion and a connector in a heating device according to a third embodiment.

### DETAILED DESCRIPTION

Hereinafter, embodiments of the present disclosure will be described with reference to the drawings. It is noted that the following embodiments are each an example of embodying the present disclosure and do not limit the technical scope of the present disclosure.

### First embodiment

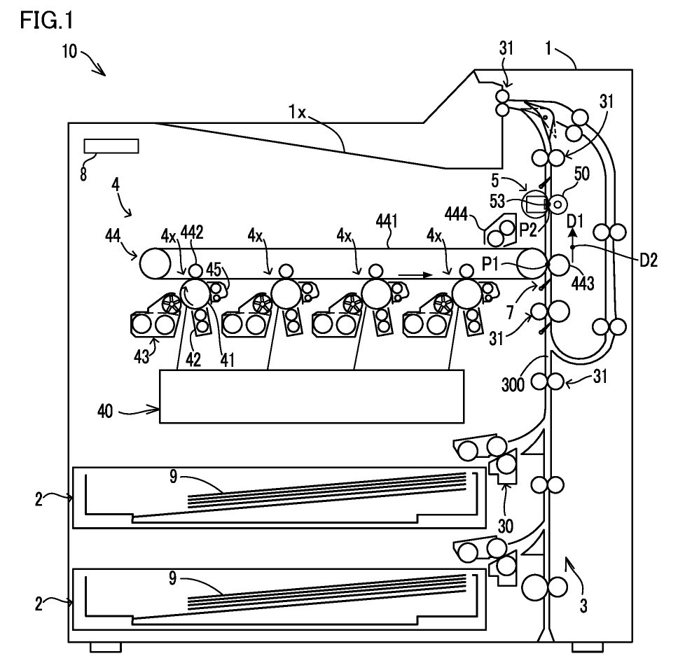

A heating device 53 according to a first embodiment is included in a fixing device 5 of an image forming apparatus 10 (see FIG. 1).

### Configuration of image forming apparatus 10

The image forming apparatus 10 includes a printing device 4 that performs print processing for forming an image on a paper sheet 9.

The printing device 4 performs the print processing by electrophotography. The paper sheet 9 is an example of a sheet-like image forming medium.

As shown in FIG. 1, the image forming apparatus 10 includes a sheet conveying device 3, the printing device 4, and a control device 8 provided in a main body portion 1.

The printing device 4 includes one or more image forming units 4x, a laser scanning unit 40, a transfer device 44, and a fixing device 5. The image forming unit 4x includes a drum-type photoconductor 41, a charging device 42, a developing device 43, a drum cleaning device 45, and the like.

The sheet conveying device 3 includes a sheet feed device 30 and a plurality of conveying roller pairs 31. The sheet feed device 30 feeds the paper sheet 9 stored in a sheet storing portion 2 to a conveying path 300 in the main body portion 1. The conveying path 300 forms a path for conveying the paper sheet 9.

The plurality of conveying roller pairs 31 rotate by a driving force of a motor (not shown) to convey the paper sheet 9 along the conveying path 300 and further discharge the paper sheet 9 onto a discharge tray 101.

The paper sheet 9 passes through a transfer position P1 and a fixing position P2 on the conveying path 300 to be discharged onto the discharge tray 101.

In descriptions below, a direction in which the paper sheet 9 is conveyed along the conveying path 300 will be referred to as a conveying direction D01. The fixing position P2 is a position on a downstream side of the conveying direction D01 with respect to the transfer position P1.

Further, a direction that intersects with the conveying direction D01 on the conveying path 300 will be referred to as a main direction D1. In the present embodiment, the main direction D1 is a direction orthogonal to the conveying direction D01.

The printing device 4 forms a toner image on the paper sheet 9 conveyed along the conveying path 300. The toner is an example of granular developer.

The image forming apparatus 10 shown in FIG. 1 is a tandem-type color image forming apparatus. Therefore, the printing device 4 includes four image forming units 4x respectively corresponding to the toner in the four colors of yellow, cyan, magenta, and black.

In each of the image forming units 4x, the photoconductor 41 rotates, and the charging device 42 charges a surface of the photoconductor 41. Furthermore, the laser scanning unit 40 writes an electrostatic latent image on the surface of the photoconductor 41 by scanning with a laser beam.

Furthermore, the developing device 43 supplies the toner to the surface of the photoconductor 41 to develop the electrostatic latent image into the toner image.

The photoconductor 41 is an example of an image-carrying member which rotates while carrying the toner image. Each of the image forming units 4x is an example of an image forming portion which forms the toner image on the surface of the photoconductor 41.

The transfer device 44 transfers the toner image from the photoconductor 41 onto the paper sheet 9. The transfer device 44 includes an intermediate transfer belt 441, four primary transfer devices 442 respectively corresponding to the four image forming units 4x, a secondary transfer device 443, and a belt cleaning device 444.

The primary transfer device 442 transfers the toner image formed on the surface of the photoconductor 41 onto a surface of the intermediate transfer belt 441. The secondary transfer device 443 transfers the toner image that has been transferred onto the intermediate transfer belt 441 onto the paper sheet 9 at the transfer position P1 on the conveying path 300.

It is noted that when the image forming apparatus 10 is a monochrome image forming apparatus, the secondary transfer device 443 transfers the toner image formed on the photoconductor 41 onto the paper sheet 9 at the transfer position P1.

The drum cleaning device 45 removes waste toner remaining on the surface of the photoconductor 41. The belt cleaning device 444 removes the waste toner remaining on the intermediate transfer belt 441.

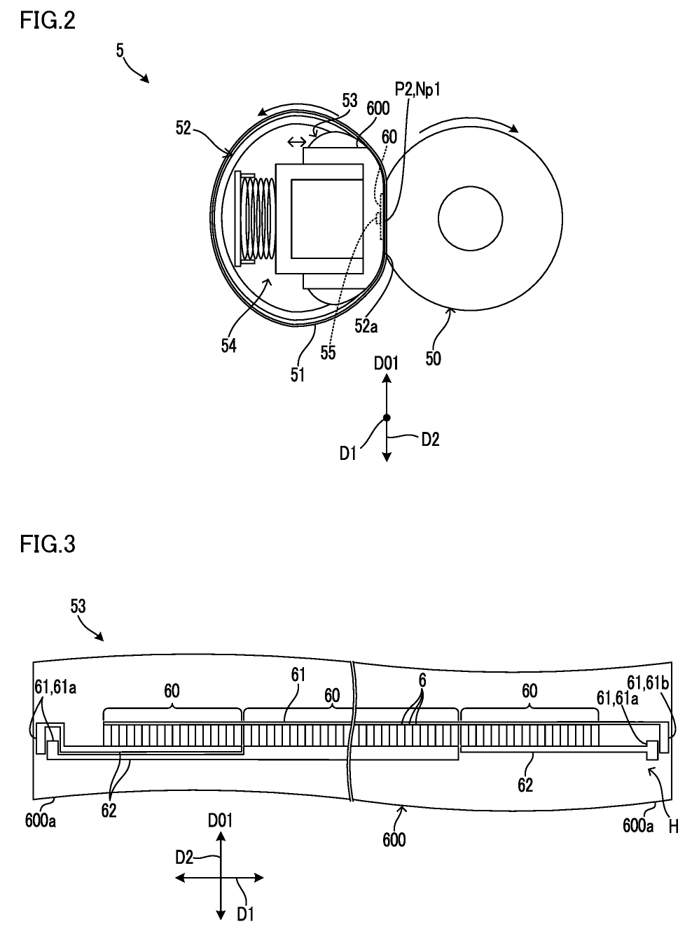

The fixing device 5 includes a pressure roller 50 and a heating device 53 (see FIG. 1 and FIG. 2 ). The fixing device 5 heats and pressurizes the toner image on the paper sheet 9 while conveying the paper sheet 9 at the fixing position P2 on the conveying path 300. Thus, the fixing device 5 fixes the toner image onto the paper sheet 9.

### Control device 8

The control device 8 executes various types of data processing and control of devices such as the sheet conveying device 3 and the printing device 4. The control target of the control device 8 includes the fixing device 5.

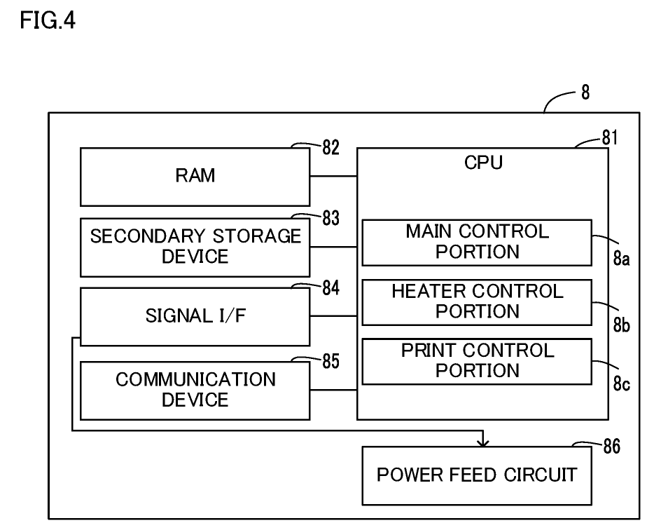

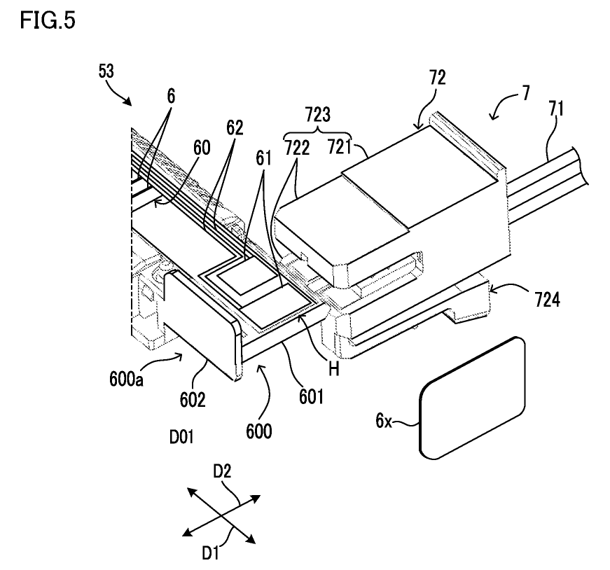

As shown in FIG. 4, the control device 8 includes a CPU (Central Processing Unit) 81 and peripheral devices. The peripheral devices include a RAM (Random Access Memory) 82, a secondary storage device 83, a signal interface 84, and the like.

The control device 8 also includes a communication device 85 and a power feed circuit 86.

The CPU 81 is a processor that executes computer programs to execute various types of data processing and control.

The RAM 82 is a computer-readable volatile storage device. The RAM 82 primarily stores the computer programs to be executed by the CPU 81 and data to be output and referenced by the CPU 81 during the process of executing the various types of processing.

The CPU 81 includes a plurality of processing modules that are realized by executing the computer programs. The plurality of processing modules include a main control portion 8a, a heater control portion 8b, a print control portion 8c, and the like.

The main control portion 8a executes start control to start the various types of processing or the like in accordance with an operation made to an operation device (not shown).

The heater control portion 8b controls a power feed amount to the heating device 53 by fixing temperature control. The heater control portion 8b controls the power feed circuit 86 to adjust the power feed amount to the heating device 53.

The power feed circuit 86 supplies power that is based on a power supply command from the heater control portion 8b to the heating device 53.

The print control portion 8c controls the sheet conveying device 3. Further, the print control portion 8c causes the printing device 4 to execute the print processing in sync with the conveyance of the paper sheet 9 by the sheet conveying device 3.

The secondary storage device 83 is a computer-readable non-volatile storage device. For example, one or both of a flash memory and a hard disk drive may be adopted as the secondary storage device 83.

The signal interface 84 converts signals output from various sensors such as a temperature sensor 55 into digital data, and transmits the digital data to the CPU 81. In addition, the signal interface 84 converts control commands output by the CPU 81 into control signals, and transmits the control signals to the devices to be controlled.

The communication device 85 executes communication with other apparatuses such as a host apparatus that transmits a print job to the image forming apparatus 10. The CPU 81 communicates with the other apparatuses via the communication device 85.

In descriptions below, a direction that intersects with the main direction D1 will be referred to as a sub direction D2. The sub direction D2 is a direction along the conveying direction D01.

### Fixing device 5

As shown in FIG. 2, the fixing device 5 includes the pressure roller 50, a fixing member 51, a guide member 52, the heating device 53, a bias mechanism 54, and the temperature sensor 55. The pressure roller 50, the fixing member 51, the guide member 52, and the heating device 53 are each arranged along the main direction D1 at the fixing position P2.

The fixing member 51 is a flexible cylindrical member. In other words, the fixing member 51 is an endless belt-like flexible cylindrical body. For example, the fixing member 51 is a cylindrical film member.

The pressure roller 50 rotates by a driving force of a motor (not shown). The pressure roller 50 forms a nip Np1 between the pressure roller 50 and the fixing member 51. The nip Np1 is formed at the fixing position P2.

The pressure roller 50 biases the paper sheet 9 that passes through the fixing position P2 toward the fixing member 51. The pressure roller 50 is an example of a pressure member which rotates while biasing the paper sheet 9 on which the toner image has been formed toward the fixing member 51.

The fixing member 51 rotates by being driven by the rotation of the pressure roller 50. The guide member 52 guides an inner surface at both end portions of the fixing member 51 in the main direction D1 along an annular path.

The heating device 53 is arranged inside the annular fixing member 51 and heats the fixing member 51. The heating device 53 includes a heater H having one or more resistance blocks 60 formed thereon, and a base member 600 which holds the heater H (see FIG. 2 and FIG. 3).

The main direction D1 is a longitudinal direction of the fixing member 51, the base member 600, and the pressure roller 50. The sub direction D2 is a short direction of the fixing member 51, the base member 600, and the pressure roller 50.

The base member 600 is arranged along the main direction D1. For example, the base member 600 is a molded member formed of synthetic resin. The bias mechanism 54 biases the base member 600 toward the transfer position P1. Thus, a heating surface of the heater H held by the base member 600 comes into contact with the inner surface of the fixing member 51.

The bias mechanism 54 elastically biases the base member 600 using an elastic member such as a spring. The heater H is arranged on a groove of the base member 600 (see FIG. 3).

In the example shown in FIG. 3, the heater H includes a plurality of resistance blocks 60 aligned along the main direction D1. Each of the resistance blocks 60 includes a plurality of resistors 6 arrayed in the main direction D1.

Each of the resistors 6 is a heating element which generates heat when a voltage is applied thereto. The plurality of resistors 6 are arranged at first intervals in the main direction D1. Further, the plurality of resistance blocks 60 are arranged at second intervals in the main direction D1.

As the fixing member 51 rotates by being driven, the inner surface of the fixing member 51 slides against the heating surface of the heater H. The fixing member 51 is heated by the plurality of resistance blocks 60 that generate heat.

The heater H is a planar heater including the plurality of resistors 6 (see FIG. 4). A lubricant is applied onto the inner surface of the fixing member 51.

In addition to the plurality of resistance blocks 60, a plurality of input electrodes 61 and a plurality of transmission patterns 62 are also arranged on the heating surface of the heater H. Each of the plurality of input electrodes 61 and the plurality of transmission patterns 62 is, for example, a conductive member such as a copper foil or a copper plate.

The plurality of input electrodes 61 are formed at the end portion of the heater H in the main direction D1, and are arranged on a base member end portion 600a, which is an end portion of the base member 600 in the main direction D1. The plurality of input electrodes 61 are electrically connected to the plurality of resistors 6 by the plurality of transmission patterns 62.

The plurality of input electrodes 61 include a plurality of anodes 61a and at least one cathode 61b to each of which a voltage supplied to the plurality of resistance blocks 60 is applied.

The temperature sensor 55 senses a temperature of the heating device 53. For example, the temperature sensor 55 is a thermistor. In the present embodiment, the temperature sensor 55 is in contact with the rear surface of the heater H opposite to the heating surface thereof to measure the temperature..

The temperature sensed by the temperature sensor 55 is used for the fixing temperature control. The fixing temperature control is feedback control in which power to be supplied to the plurality of resistance blocks 60 is controlled by comparing the temperature sensed by the temperature sensor 55 with a preset target temperature.

The heating device 53 further includes a wire harness 7 that transmits power supplied from the power feed circuit 86 to the plurality of input electrodes 61 (see FIG. 5 to FIG. 8 ). The wire harness 7 includes a plurality of cables 71 connected to the power feed circuit 86 and a connector 72 connected to end portions of the plurality of cables 71.

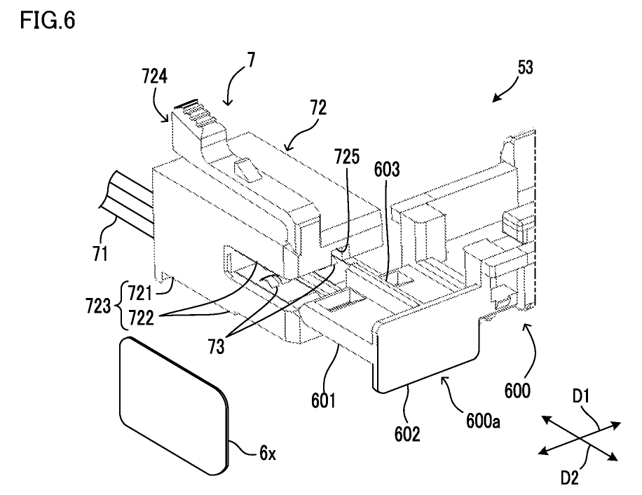

The connector 72 includes a plurality of output electrodes 73 to which power is supplied from the power feed circuit 86 via the plurality of cables 71 (see FIG. 6). Each of the output electrodes 73 is a conductive member such as a copper plate. By attaching the connector 72 to the base member end portion 600a, the plurality of output electrodes 73 come into contact with the plurality of input electrodes 61.

The output power of the power feed circuit 86 is supplied to the plurality of resistance blocks 60 via the plurality of cables 71, the plurality of output electrodes 73, and the plurality of input electrodes 61.

Incidentally, in the image forming apparatus 10, there is a fear that scattered toner will enter the connector 72 through a gap formed between the base member end portion 600a and the connector 72. The entering of the scattered toner into the connector 72 may cause an inconvenient situation such as a contact failure of the electrodes.

Meanwhile, in an area at an end portion of the fixing device 5 in the main direction D1, various devices such as a gear mechanism which drives a rotating body of the fixing device 5 are arranged at a high density, and thus a free space is small. For example, the rotating body is the pressure roller 50.

The heating device 53 has a configuration for preventing the scattered toner from entering the connector 72. Hereinafter, this configuration will be described.

The connector 72 includes a nip portion 723 and an engagement portion 724 (see FIG. 5 to FIG. 8). The nip portion 723 includes a housing portion 721 and a pair of arm portions 722. The pair of arm portions 722 are formed to extend in parallel from the housing portion 721 and oppose each other.

The housing portion 721 retains tip end portions of the plurality of cables 71. By the base member end portion 600a being inserted between the pair of arm portions 722, the pair of arm portions 722 nip the base member end portion 600a.

The plurality of output electrodes 73 are arranged on inner surfaces of the pair of arm portions 722. A state where the pair of arm portions 722 nip the base member end portion 600a is a state where the connector 72 is attached to the base member end portion 600a.

By the connector 72 being attached to the base member end portion 600a, the plurality of output electrodes 73 come into contact with the plurality of input electrodes 61.

The base member 600 includes a convex portion 603 (see FIG. 6) formed on the base member end portion 600a faced an opposite side of the surface on which the plurality of input electrodes 61 of the heater H are arranged. The convex portion 603 is formed to extend in the sub direction D2.

One of the pair of arm portions 722 includes a concave portion 725 into which the convex portion 603 is inserted. The connector 72 is attached to the base member end portion 600a along the sub direction D2. When the connector 72 is attached to the base member end portion 600a, the convex portion 603 is inserted into the concave portion 725 and guides the connector 72 along the sub direction D2.

Furthermore, by the convex portion 603 being inserted into the concave portion 725, a movement of the connector 72 attached to the base member end portion 600a in the main direction D1 is restricted.

The engagement portion 724 engages with a to-be-engaged portion 52a that is a part of the fixing device 5, to retain the connector 72 in a state where the connector 72 is attached to the base member end portion 600a. The engagement portion 724 engages with the to-be-engaged portion 52a to restrict the movement of the connector 72 in the sub direction D2.

The engagement portion 724 is elastically deformable. The engagement portion 724 is elastically deformed so as to be switched from one of an engaged state where the engagement portion 724 engages with the to-be-engaged portion 52a and a released state where the engagement thereof with the to-be-engaged portion 52a is released to the other.

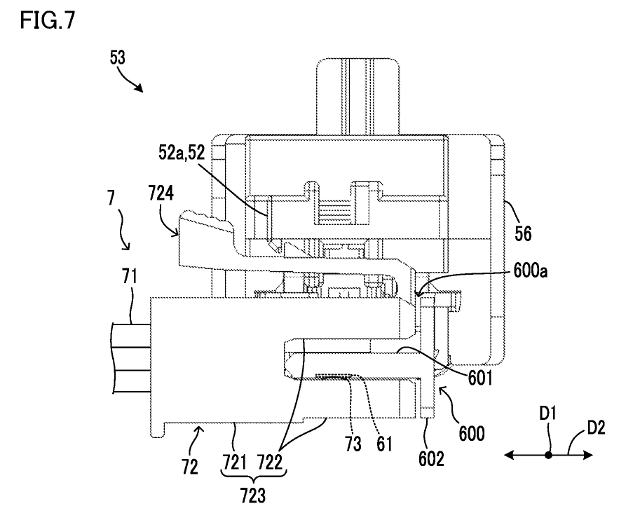

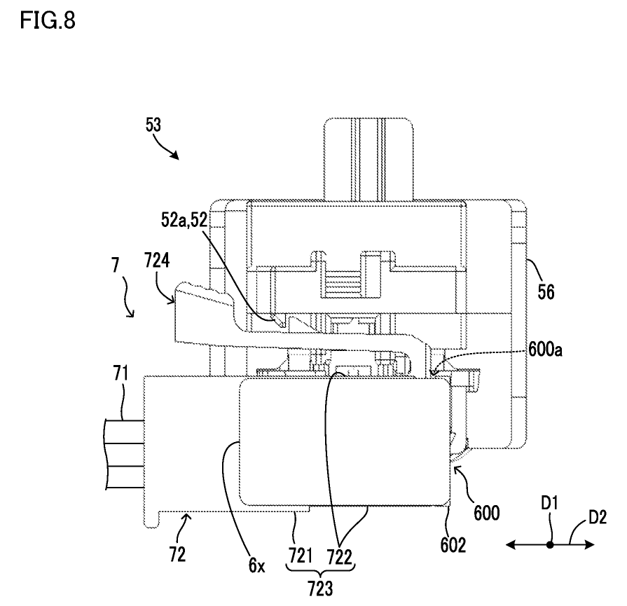

In the present embodiment, the to-be-engaged portion 52a is formed at an end portion of the guide member 52 in the main direction D1. The base member 600 and the guide member 52 are retained in a certain positional relationship by a retention member 56 (see FIG. 7 and FIG. 8).

The heating device 53 further includes a sheet member 6x that closes a gap between the connector 72 and the base member end portion 600a (see FIG. 5, FIG. 6, and FIG. 8).

The sheet member 6x is adhered to an end surface of the base member end portion 600a and a side surface of the nip portion 723, and closes the gap between the end surface of the base member end portion 600a and the side surface of the nip portion 723 (see FIG. 8). The surfaces to which the sheet member 6x is adhered are the end surface of the base member end portion 600a in the main direction D1 and an outer side surface of the nip portion 723 in the main direction D1.

FIG. 5 to FIG. 7 each show a state before the sheet member 6x is adhered, and FIG. 8 shows a state where the sheet member 6x is adhered.

For example, the sheet member 6x is an adhesive sheet having an adhesive formed on one surface thereof. In this case, the sheet member 6x is adhered to the end surface of the base member end portion 600a and the side surface of the nip portion 723 by the adhesive.

In the present embodiment, the base member end portion 600a includes a first plate-like portion 601 and a second plate-like portion 602 (see FIG. 5 to FIG. 7). The first plate-like portion 601 is a portion where the plurality of input electrodes 61 are arranged and which is inserted between the pair of arm portions 722. The second plate-like portion 602 is a portion that is continuous with the first plate-like portion 601 and opposes tip ends of the pair of arm portions 722.

The sheet member 6x is adhered to the side surface of the nip portion 723 in the connector 72, an end surface of the first plate-like portion 601, and an end surface of the second plate-like portion 602. This allows the sheet member 6x to be stably adhered to a relatively wide surface.

An area occupied by the sheet member 6x is very small in the heating device 53. By adopting the heating device 53, the configuration for preventing the scattered toner from entering the connector 72 can be realized with a very small space.

### Second embodiment

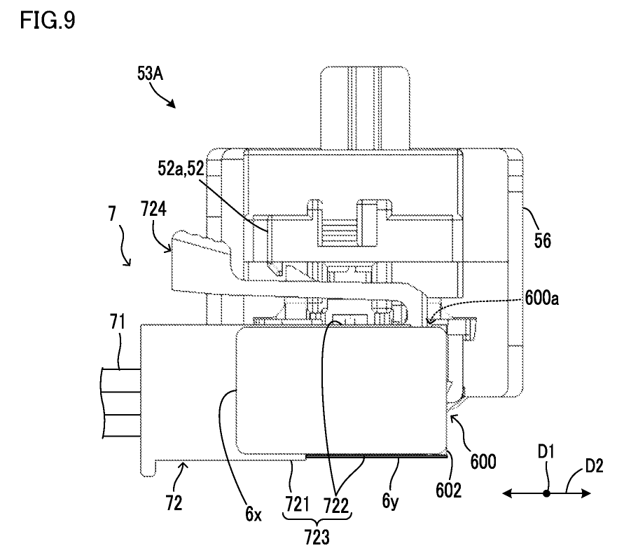

Next, a heating device 53A according to a second embodiment will be described with reference to FIG. 9.

The heating device 53A has a configuration in which a sheet member 6y is added to the heating device 53. The sheet member 6y is adhered to a lower surface of the connector 72 and a lower surface of the base member end portion 600a. In the present embodiment, the lower surface of the base member end portion 600a is a lower surface of the second plate-like portion 602.

The sheet member 6y closes a gap between the lower surface of the connector 72 and the lower surface of the base member end portion 600a. By adopting the heating device 53A, the scattered toner is more-reliably prevented from entering the connector 72.

### Third embodiment

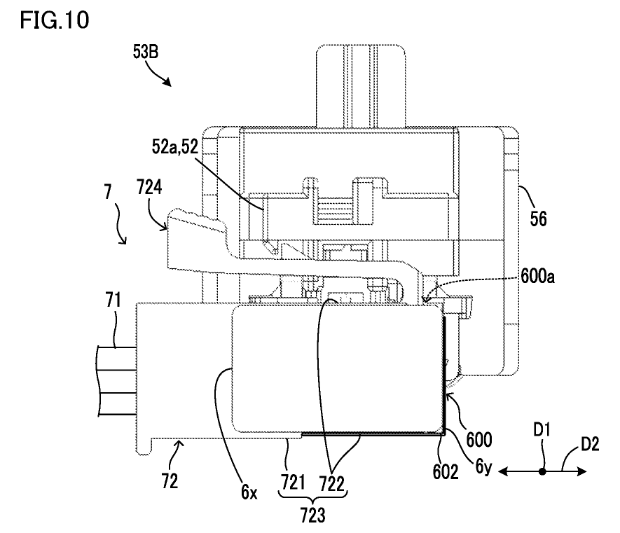

Next, a heating device 53B according to a third embodiment will be described with reference to FIG. 10. The heating device 53B is a modified example of the heating device 53A.

In the heating device 53B, the sheet member 6y is adhered to the lower surface of the connector 72 and to the lower surface of the second plate-like portion 602 and an outer surface of the second plate-like portion 602 in the base member end portion 600a.

The sheet member 6y closes the gap between the lower surface of the connector 72 and the lower surface of the base member end portion 600a. When the heating device 53B is adopted, effects similar to those obtained when the heating device 53A is adopted can be obtained. In addition, in the heating device 53B, the sheet member 6y is stably adhered to a relatively wide surface.

### Notes of disclosure

Hereinafter, a general outline of the disclosure extracted from the embodiment described above will be noted. It is noted that the respective configurations and processing functions described in the notes below can be sorted and arbitrarily combined as appropriate.

### Note 1

A heating device, including:

a heater which includes,

a plurality of resistors arrayed in a main direction on a surface;

a plurality of input electrodes which are electrically connected to the plurality of resistors and are arranged on the surface of an end portion in the main direction;

a connector which includes a nip portion including a pair of arm portions that nip a base member end portion which is an end portion of the base member in the main direction, and a plurality of output electrodes which are arranged on inner surfaces of the pair of arm portions and come into contact with the plurality of input electrodes; and

a sheet member which is adhered to an end surface of the base member end portion and a side surface of the nip portion and closes a gap between the end surface of the base member end portion and the side surface of the nip portion.

### Note 2

The heating device according to note 1, in which

the base member end portion includes

a first plate-like portion in which the plurality of input electrodes of the heater are arranged and which is inserted between the pair of arm portions, and

a second plate-like portion which is continuous with the first plate-like portion and opposes tip ends of the pair of arm portions, and

the sheet member is adhered to an end surface of the first plate-like portion and an end surface of the second plate-like portion.

### Note 3

A fixing device, including:

the heating device according to note 1 or 2;

a cylindrical fixing member heated by the heating device; and

a pressure member which rotates while biasing a paper sheet on which a toner image has been formed toward the fixing member.

### Note 4

An image forming apparatus, including:

an image forming portion which forms a toner image on a surface of an image-carrying member;

a transfer device which transfers the toner image from the image-carrying member onto a paper sheet; and

the fixing device according to note 3 which heats and pressurizes the toner image formed on the paper sheet.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A heating device, comprising:
a heater which includes,
a plurality of resistors arrayed in a main direction on a surface;
a plurality of input electrodes which are electrically connected to the resistors and are arranged on the surface of an end portion in the main direction;
a base member which holds the heater;
a connector which includes a nip portion including a pair of arm portions that nip a base member end portion which is an end portion of the base member in the main direction, and a plurality of output electrodes which are arranged on inner surfaces of the pair of arm portions and come into contact with the plurality of input electrodes; and
a sheet member which is adhered to an end surface of the base member end portion and a side surface of the nip portion and closes a gap between the end surface of the base member end portion and the side surface of the nip portion.

2. The heating device according to claim 1, wherein
the base member end portion includes
a first plate-like portion in which the plurality of input electrodes of the heater are arranged and which is inserted between the pair of arm portions, and
a second plate-like portion which is continuous with the first plate-like portion and opposes tip ends of the pair of arm portions, and
the sheet member is adhered to an end surface of the first plate-like portion and an end surface of the second plate-like portion.

3. A fixing device, comprising:
the heating device according to claim 1;
a cylindrical fixing member heated by the heating device; and
a pressure member which rotates while biasing a paper sheet on which a toner image has been formed toward the fixing member.

4. An image forming apparatus, comprising:
an image forming portion which forms a toner image on a surface of an image-carrying member;
a transfer device which transfers the toner image from the image-carrying member onto a paper sheet; and
the fixing device according to claim 3 which heats and pressurizes the toner image formed on the paper sheet.
